(19) United States
(12) Patent Application Publication
(10) Pub. No.: US 2011/0149203 A1
(43) Pub. Date: Jun. 23, 2011

(54) BACKLIGHT UNIT AND DISPLAY MODULE APPLYING THE SAME

(75) Inventors: Tae-Joon KIM, Yongin City (KR); Tae-Eun KIM, Yongin-City (KR); Young-Bee CHU, Yongin-City (KR)

(73) Assignee: Samsung Mobile Display Co., Ltd., Yongin-city (KR)

(21) Appl. No.: 12/969,851

(22) Filed: Dec. 16, 2010

(30) Foreign Application Priority Data
Dec. 18, 2009 (KR) 10-2009-0126920

(51) Int. Cl. G02F 1/13357; F21V 7/22

(52) U.S. Cl. 349/62; 362/613; 362/607

(57) ABSTRACT

A backlight unit and a display module employing the backlight unit. The backlight unit of a display apparatus displaying an image, the backlight unit including: a light guide panel guiding light to the display apparatus; a circuit board having a plurality of light source devices mounted thereon and which is formed at a side of the light guide panel; a light leakage preventing portion including: an interval removing portion formed in the light guide panel, and an adhesive portion attached to the interval removing portion and formed on the circuit board, wherein the light leakage preventing portion is formed in a portion of the circuit board attached to the light guide panel. The light leakage preventing portion is formed in a side portion of a light guide panel. Thus, even when an adhesive portion is not formed in front of a light source device of a circuit board, a height difference between a portion of the circuit board where the adhesive portion is formed and a portion of the circuit board where the adhesive portion is not formed can be compensated, thereby improving brightness of a backlight unit and preventing light from leaking.

### CROSS-REFERENCE TO RELATED APPLICATION

This application claims the benefit of Korean Patent Application No. 10-2009-0126920, filed Dec. 18, 2009, in the Korean Intellectual Property Office, the disclosure of which is incorporated herein by reference.

### BACKGROUND

1. Field

Aspects of the present invention relate to a display module, and more particularly, to a backlight unit that prevents light incident from a light source device from leaking at a side of a light guide panel and a display module employing the backlight unit.

2. Description of the Related Art

In general, display apparatuses, such as a liquid crystal display (LCD) panel, are light receiving type-display apparatuses. The LCD panel cannot form an image by emitting light from the LCD itself, but forms an image by using an external light incident upon the LCD panel.

Since the light receiving type display apparatus cannot emit light by itself, a backlight unit is disposed on a rear surface of the LCD panel so as to emit light illuminating the LCD panel. Thus, an image can be viewed in a dark place. The backlight unit is also used as a surface light source apparatus, such as a lamp, a signboard, or another similar apparatus.

The backlight unit is classified into a direct light type and an edge light type according to a position of a light source device. The direct light type backlight unit has a structure in which a plurality of light source devices disposed under a panel directly emit light towards the panel. The edge light type backlight unit has a structure in which a plurality of light source devices, which are disposed at a side of a light guide panel, emit light towards a panel through the light guide panel.

A light source of a backlight unit uses a cold cathode fluorescent lamp (CCFL), an external electrode fluorescent lamp (EEFL), a light emitting diode (LED), or other similar light sources. The CCFL has a structure in which electrodes of both ends of a fluorescent lamp are formed inside a tube. The EEFL has a structure in which electrodes of both ends of a fluorescent lamp are formed outside of a tube. The LED has advantages, such as a compact size, low power consumption, and high reliability, and thus the LED has been widely used as a light source of a display apparatus.

Meanwhile, a liquid crystal display module includes an LCD panel displaying an image, a backlight unit for supplying light to the LCD panel, and a driving circuit board supplying an electrical signal to the LCD panel and the backlight unit.

The backlight unit includes a light guide panel and a circuit board of a light source device (hereinafter, a circuit board) on which the light source device is mounted. The circuit board is connected to a driving circuit board by soldering and receives a driving signal from the driving circuit board.

Conventionally, a light source device is mounted on a circuit board, and the light source device is attached to a side of a light guide panel using an adhesive tape toah light is emitted from the light source device to the light guide panel.

To improve brightness of the backlight unit, the adhesive tape attached to the side of the light guide panel is partially removed. In this case, an interval is formed between a side surface of the light guide panel and the circuit board, due to a height difference between the circuit board from which the adhesive tape is partially removed and the circuit board to which the adhesive tape is attached. Thus, light leaks through the interval, thereby deteriorating the quality of an image.

### SUMMARY OF THE INVENTION

Aspects of the present invention provide a backlight unit having an improved structure in which an interval, or in other words a gap, is not formed between a side portion of a light guide panel and a circuit board on which a plurality of light source devices are mounted, and a display module employing the backlight unit.

According to an aspect of the present invention, there is provided a backlight unit of a display apparatus displaying an image, the backlight unit including: a light guide panel guiding light to the display apparatus; a circuit board having a plurality of light source devices mounted and which is formed at a side of the light guide panel; a light leakage preventing portion including: an interval removing portion formed in the light guide panel, and an adhesive portion attached to the interval removing portion and formed on the circuit board, wherein the light leakage preventing portion is formed in a portion where the circuit board is attached to the light guide panel.

According to another aspect of the present invention, the interval removing portion is formed to have a height different from that of a height of an upper surface of a side portion of the light guide panel in one direction of the side portion of the light guide panel, and wherein the interval removing portion includes a plurality of grooves each formed to correspond to a portion of the circuit board on which the adhesive portion is attached.

According to another aspect of the present invention, the interval removing portions comprise a plurality of concavo-convex portions repeatedly formed in the one direction of the side portion of the light guide panel in a cross-section of the side portion of the light guide panel.

According to another aspect of the present invention, a thickness of the interval removing portions, from an upper surface of the side portion of the light guide panel to a bottom surface of the interval removing portion, is the same as or greater than a thickness of the adhesive portion so as to completely accommodate the adhesive portion. The adhesive portion may be attached to the interval removing portion, and the upper surface of the side portion of the light guide panel and a surface of the adhesive portion contacting the circuit board may from a same horizontal plane.

According to another aspect of the present invention, the circuit board attached to the light guide panel is flexible and the circuit board includes: a film having a patterned wiring line; and a plurality of light source devices are spaced apart from one another on the film, wherein the adhesive portion is attached between adjacent ones of the light source devices on the flexible film. The flexible film may have a strip shape extending in the one direction of the side portion of the light guide panel. The adhesive portion may cover a portion of the flexible film from one end portion to another end portion of the flexible film in a width direction of the flexible film.

According to another aspect of the present invention, the light source device is formed at the one end portion of the flexible film, and a non-adhesive portion of the flexible film where the adhesive portion is not formed is in front of a portion of the flexible film where the light source device is formed.

According to another aspect of the present invention, the non-adhesive portion of the flexible film is located in an area contacting the upper surface of the side portion of the light guide panel.

According to another aspect of the present invention, the non-adhesive portion of the flexible film covers corresponding areas of the upper surface of the side portion of the light guide panel and the light source device is disposed in front of a side wall of the light guide panel.

According to another aspect of the present invention, the light guide panel includes a light guide portion guiding light to the display apparatus; and a side portion extending from the light guide portion, the side portion including: a light incident portion thicker that the light guide portion, and an inclined portion that connects the light guide portion and the light incident portion, wherein the side portion extends from and is space apart from the light guide portion in parallel.

According to another aspect of the present invention, there is provided a display module including: a display apparatus displaying an image; a backlight unit formed below the display apparatus, the backlight unit including: a light guide panel guiding light to the display apparatus; and a circuit board formed at a side of the light guide panel and including light source devices mounted thereon; and a light leakage preventing portion formed in a portion of the circuit board attached to the light guide panel, the light leakage preventing portion including: an interval removing portion formed in the light guide panel; and an adhesive portion attached to the interval removing portion and formed in the circuit board.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view illustrating a display module according to an embodiment of the present invention;

FIG. 2 is an exploded enlarged perspective view illustrating a part of a backlight unit of the display module of FIG. 1; and

FIG. 3 is a perspective view illustrating a coupling state of the backlight unit of FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Now, an exemplary embodiment according to the present invention will be described in detail with reference to the accompanying drawings.

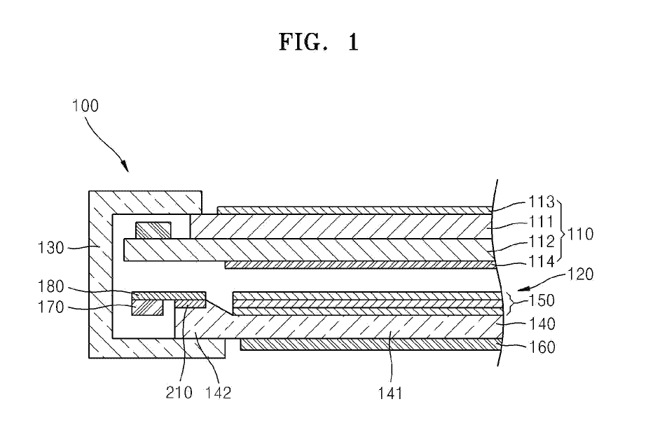

FIG. 1 is a cross-sectional view illustrating a display module 100 according to an embodiment of the present invention. Referring to FIG. 1, the display module 100 includes a liquid crystal display (LCD) panel 110, a backlight unit 120 emitting light to the LCD panel 110, and a case 130 accommodating the LCD panel 110 and the backlight unit 120. The backlight unit 120 includes a light guide panel 140, a plurality of optical sheets 150, a reflective sheet 160, and a circuit board 180 on which a plurality of light source devices 170 are mounted.

The LCD panel 110 includes a first substrate 111, a second substrate 112, and a liquid crystal (not shown) that is injected between the first substrate 111 and the second substrate 112. For example, in an active matrix type LCD panel, a plurality of gate lines and a plurality of data lines intersect inside the first substrate 111 and a thin film transistor (TFT) is formed at each intersection. The thin film transistor is connected to each pixel electrode formed in each pixel. Although not shown, red, green, and blue color filters are formed inside the second substrate 112, and a transparent common electrode covering the red, green, and blue color filters is formed on the color filters. Polarizing plates 113 and 114 selectively transmitting specific light are attached to external surfaces of the first substrate 111 and the second substrate 112, respectively.

The light guide panel 140 is formed below the LCD panel 110. The light guide panel 140 guides light emitted from the light source devices 170 to the light to the LCD panel 110. The light guide panel 140 is formed in a specific pattern in order to provide a uniform surface light source. However, aspects of the present invention are not limited thereto and the light guide panel 140 may be formed in a variety of patterns.

The optical sheets 150 are formed between the LCD panel 110 and the light guide panel 140. The optical sheet 150 formed of at least one sheet may include a diffusion sheet and a prism sheet. The optical sheet 150 may diffuse or collect light guided from the light guide panel 140 and allow the light to be incident on the LCD panel 110 as a more uniform surface light source.

The reflective sheet 160 opposing to the optical sheet 150 is formed on a rear surface of the light guide panel 140. The reflective sheet 160 reflects light having passed through the rear surface of the light guide panel 140 towards the LCD panel 110 so as to improve the light emission efficiency.

The circuit board 180 on which the plurality of light source devices 170 are mounted is formed on a side portion 142 of the light guide panel 140. Thus, light is emitted from the light source devices 170 towards the light guide panel 140 according to an electrical signal transmitted to the circuit board 180.

The light source devices 170 uses a cold cathode fluorescent lamp (CCFL), an external electrode fluorescent lamp (EEFL), or a light emitting diode (LED), and preferably, uses a plurality of white LEDs emitting white light. However, aspects of the present invention are not limited thereto, and the light source devices 170 may use other suitable devices to emit white light. Since a circuit pattern is formed in the circuit board 180, the circuit board 180 is formed of a flexible printed cable capable of controlling a stable voltage and flickering of the plurality of light source devices 170. However, aspects of the present invention are not limited thereto and the circuit board 180 may be formed of other suitable devices or materials.

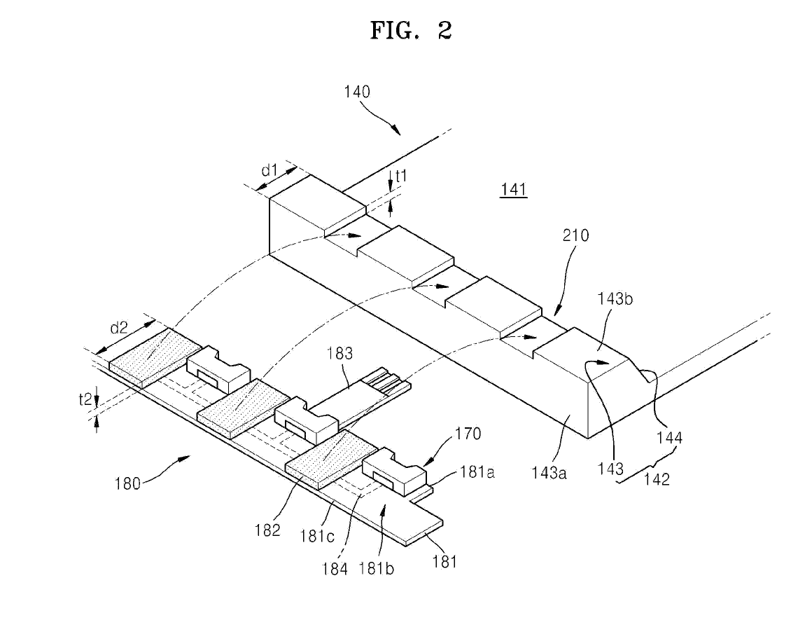

When the circuit board 180 is coupled to the side portion 142 of the light guide panel 140, light leakage preventing portions are formed in the circuit board 180 and the side portion 142 of the light guide panel 140 in order to remove an interval between the circuit board 180 and the side portion 142 of the light guide panel 140. The light leakage preventing portion includes an interval removing portion 210 formed at the side portion 142 of the light guide panel 140, and an adhesive tape 182 (see FIG. 2) formed in the circuit board 180.

FIG. 2 illustrates a circuit board 180 on which a plurality of light source devices 170 are mounted, wherein the circuit board 180 is formed on a side portion 142 of a light guide panel 140. Referring to FIG. 2, the light guide panel 140 includes a flat light guide portion 141. The light guide portion 141 is formed in a specific pattern in order to provide a uniform surface light source.

For example, a plurality of light guide patterns are printed in the light guide portion 141 using ink containing bead-shaped titanium oxide, glass, or acryl in order to scatter and diffuse light incident to a surface of a transparent acryl resin. However, aspects of the present invention are not limited thereto, and the light guide patterns may also be formed using a non-print method, for example, a stamping method using a mold or an injection molding method. More preferably, the light guide pattern may be processed using a laser beam, and a cross section of the light guide pattern may be formed in a serrated shape by evaporation of an acryl resin. A minute serrated shape functions as a microlens, and thus expands diffusion of light in different directions.

The light guide pattern is formed in a dot shape including a groove having a predetermined depth. However, aspects of the present invention are not limited thereto, and the light guide pattern may be formed in a quadrilateral shape, a combination of the dot shape and the quadrilateral shape, a dotted line shape including intermittent grooves each having a predetermined depth, or a linear shape including continuous grooves. In order to increase light diffusion and light scattering, the size of the groove of the light guide pattern may be gradually increased or a pitch of the groove may be gradually decreased as the distance between the light guide pattern and the light source devices 170 increases.

The side portion 142 extending from the light guide portion 141 has a different thickness than a thickness of the light guide portion 141. That is, the side portion 142 is spaced apart at a predetermined distance from the light guide portion 141 in a horizontal direction. The side portion 142 includes a light incident portion 143, having a thickness greater than the thickness of the light guide portion 141, and an inclined portion 144 a connecting the light guide portion 141 and the light incident portion 143. The light source devices 170 are formed on a side wall 143a so that light is incident on the side wall 143a of the light incident portion 143. Thus, light emitted from the light source devices 170 is incident on the side wall 143a of the light incident portion 143, is guided through the inside of the light guide portion 141, and is guided towards the LCD panel 110 (see FIG. 1).

The circuit board 180 on which the plurality of light source devices 170 are mounted is formed on an upper surface 143b of the light incident portion 143. The circuit board 180 includes a flexible film 181. A wiring line 184 is formed inside the flexible film 181. The flexible film 181 has a strip shape extending in a lengthwise direction of a short side of the light incident portion 143.

The plurality of light source devices 170 are mounted on the flexible film 181. The light source devices 170 are spaced apart from one another at a predetermined distance and are electrically connected to one another via the wiring line 184. The light source devices 170 are formed at an end portion 181a of the flexible film 181.

A plurality of adhesive tapes 182 each has a predetermined thickness and are disposed between respective ones of the light source devices 170 on the flexible film 181. The adhesive tapes 182 are used to firmly fix the circuit board 180 on the upper surface 143b of the light incident portion 143. The adhesive tape 182 also covers a portion from the end portion 181a to the other end portion 181c of the flexible film 181 along a width direction of the flexible film 181.

On the other hand, a front portion of the flexible film 181 is a non-adhesive portion 181b. The front portion of the flexible film 181 is the portion where the light source devices 170 are not formed in the flexible film 181. Thus, an adhesive portion where the adhesive tape 182 is formed in a lengthwise direction of the flexible film 181 and the non-adhesive portion 181b where the adhesive tape 182 is not formed are repeatedly formed in the flexible film 181.

Meanwhile, when the circuit board 180 is attached to the upper surface 143b of the light incident portion 143 via the adhesive tape 182, the light source devices 170 are formed in front of the side wall 143a of the light incident portion 143. For this, a distance d1 of the upper surface 143b of the light incident portion 143 is less than a distance d2 of the flexible film 181. In this case, the distance d2 of the flexible film 181 is formed so that the non-adhesive portion 181b where the adhesive tape 182 is not formed covers the upper surface 143b of the light incident portion 143. Thus, the light source devices 170 are formed in front of the side wall 143a of the light incident portion 143.

In this case, a plurality of interval removing portions 210 are formed in the light incident portion 143 of the light guide panel 140. That is, the interval removing portions 210 are formed to each have a different height from that of the upper surface 143b of the light incident portion 143 along a short side of the light incident portion 143. In the current embodiment, the interval removing portion 210 includes a plurality of grooves each formed to correspond to a portion to which the adhesive tape 182 is attached. A plurality of concavo-convex portions (not shown)_repeatedly formed along a short side of the light incident portion 143 are formed in a cross-section of the light incident portion 143, thus forming the interval removing portions 210. Each of the interval removing portions 210 is formed to have a size capable of covering a width of the adhesive tape 182 along the short side of the light incident portion 143.

As such, the interval removing portions 210 are formed to each have a different height from that of the upper surface 143b of the light incident portion 143 along a short side of the light incident portion 143. A first thickness t1 of a portion from the upper surface 143b of the light incident portion 143 to a bottom surface of the interval removing portion 210 is the same as or greater than a second thickness t2 of the adhesive tape 182. Thus, when the adhesive tape 182 is attached to the interval removing portion 210, the adhesive tape 182 and the upper surface 143b of the light incident portion 143 form a substantially horizontal plane. However, aspects of the present invention are not limited thereto, and the first thickness t1 may be other suitable thicknesses.

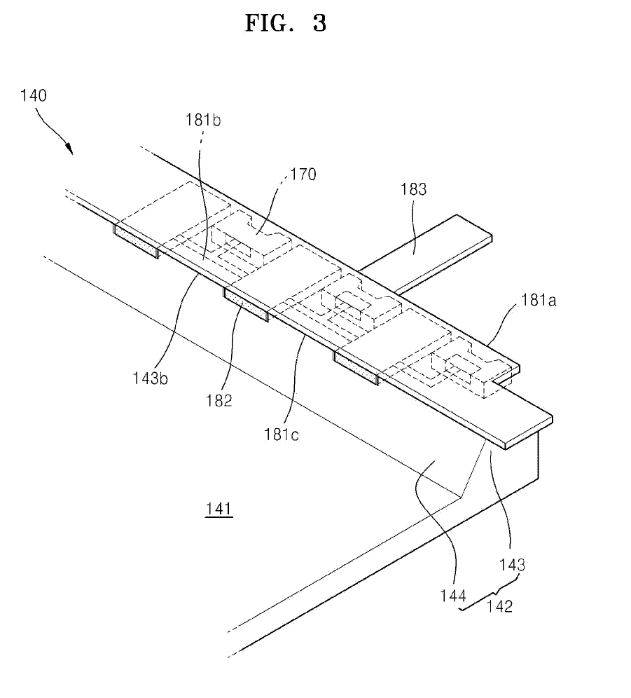

Coupling between the light guide panel 140 and the circuit board 180 will be described with reference to FIGS. 2 and 3 as follows. The plurality of light source devices 170 are mounted on the flexible film 181. The light source devices 170 are spaced apart at a predetermined distance in a lengthwise direction of the flexible film 181. In this case, the light source devices 170 are electrically connected to one another via the wiring line 182 buried inside the flexible film 181 and are controlled by an electrical signal transmitted via an external connector 183. However, aspects of the present invention are not limited thereto, and the light source devices 170 may be controlled by other signals via other elements.

A surface of the flexible film 181 corresponding to a portion of the flexible film 181 between an adjacent pair of the light source devices 170 is exposed to the outside, and the adhesive tape 182 is attached to the exposed surface. The plurality of adhesive tapes 182, each having the second thickness t2, are attached over a portion from among portions of the flexible film 181 disposed between the one end portion 181a and the other end portion 181c. The adhesive tape 182 is attached to the exposed surface of the flexible film 181 in a lengthwise direction of the flexible film 181. The adhesive tape 182 is attached between the adjacent ones of the light source devices 170 so that the adhesive tape 182 includes at least one portion from among portions disposed between the one end portion 181a and the other end portion 181c of the flexible film 181. However, aspects of the present invention are not limited thereto, and the adhesive tape 182 may be attached at other suitable locations.

The side portion 142 extending from the light guide portion 141 includes the light incident portion 143. An upper surface of the interval removing portion 210 and the upper surface 143b of the light incident portion 143 have different heights from each other, and thus a plurality of concavo-convex portions repeatedly formed along a short side of the light guide panel 140 are formed in a cross-section of the light incident portion 143. That is, the interval removing portions 210, each having the first thickness t1, are formed in the light incident portion 143.

A surface of the flexible film 181, corresponding to a portion of the flexible film 181 where the adhesive tape 182 is formed, corresponds to the upper surface 143b of the light incident portion 143, as illustrated by dotted arrows in FIG. 2. The adhesive tape 182 is attached to the interval removing portion 210 so as to fix the circuit board 180 to the light incident portion 143.

In this case, the first thickness t1 from the upper surface 143b of the light incident portion 143 to a bottom surface of the interval removing portion 210 is the same as or greater than the second thickness t2 of the adhesive tape 182. Thus, the adhesive tape 182 is accommodated in the interval removing portion 210. The adhesive tape 182 contacts a surface of the flexible film 181 and forms a horizontal plane with the upper surface 143b of the light incident portion 143. Also, the front portion of a region of the flexible film 181, on which the light source devices 170 are mounted, is located in an area contacting the upper surface 143b of the light incident portion 143.

As described above, in the circuit board 180 on which the light source devices 170 is mounted, the adhesive tape 182 is attached to the interval removing portion 210. As such, an adhesive portion where the adhesive tape 182 is formed in a lengthwise direction of the flexible film 181 and the non-adhesive portion 181b where the adhesive tape 182 is not formed are repeatedly formed in the flexible film 181 and generate a difference in height along the circuit board 180. However, when the flexible film 181 is attached to the upper surface 143b of the light incident portion 143, the difference in height is accommodated by the interval removing portion 170 and an interval, or a gap, is not formed between the flexible film 181 and the upper surface 143b of the light incident portion 143, thereby preventing light from leaking through the interval.

Additionally, when the circuit board 180 is attached to the upper surface 143b of the light incident portion 143, the light source devices 170 formed adjacent to the one end portion 181a of the flexible film 181 are formed in front of the side wall 143a of the light incident portion 143.

The distance d1 of the upper surface 143b of the light incident portion 143 is formed to be greater than the distance d2 of the flexible film 181. Thus, the non-adhesive portion 181b where the adhesive tape 182 is not formed covers the upper surface 143b of the light incident portion 143, and simultaneously, is formed in front of the upper surface 143b of the light incident portion 143.

According to a backlight unit and a display module employing the backlight unit according to aspects of the present invention, a light leakage preventing portion is formed in a side portion of a light guide panel. Thus, even when an adhesive tape is not formed in front of a light source device of a circuit board, a height difference between a portion where the adhesive tape is formed and a portion where the adhesive tape is not formed can be accommodated, thereby improving brightness of a backlight unit and preventing light from leaking from respective portions.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A backlight unit of a display apparatus displaying an image, the backlight unit comprising:
a light guide panel guiding light to the display apparatus;
a circuit board having a plurality of light source devices mounted thereon and which is formed at a side of the light guide panel;
a light leakage preventing portion comprising:
an interval removing portion formed in the light guide panel; and
an adhesive portion attached to the interval removing portion and formed on the circuit board,
wherein the light leakage preventing portion is formed in a portion of the circuit board attached to the light guide panel.

2. The backlight unit of claim 1, wherein the interval removing portion is formed to have a height different from that of a height of an upper surface of a side portion of the light guide panel in one direction of the side portion of the light guide panel, and
wherein the interval removing portion comprises a plurality of grooves each formed to correspond to a portion of the circuit board on which the adhesive portion is attached.

3. The backlight unit of claim 2, wherein the interval removing portions comprise a plurality of concavo-convex portions repeatedly formed in the one direction of the side portion of the light guide panel in a cross-section of the side portion of the light guide panel.

4. The backlight unit of claim 2, wherein a thickness of the interval removing portions, from an upper surface of the side portion of the light guide panel to a bottom surface of the interval removing portion, is the same as or greater than a thickness of the adhesive portion so as to completely accommodate the adhesive portion.

5. The backlight unit of claim 4, wherein when the adhesive portion is attached to the interval removing portion, the upper surface of the side portion of the light guide panel and a surface of the adhesive portion contacting the circuit board form a same horizontal plane.

6. The backlight unit of claim 2, wherein the circuit board attached to the light guide panel is flexible and the circuit board comprises:
a film having a patterned wiring line; and
a plurality of light source devices are spaced apart from one another on the film,
wherein the adhesive portion is attached between adjacent ones of the light source devices on the flexible film.

7. The backlight unit of claim 6, wherein the flexible film has a strip shape extending in the one direction of the side portion of the light guide panel.

8. The backlight unit of claim 6, wherein the adhesive portion covers a portion of the flexible film from one end portion to another end portion of the flexible film in a width direction of the flexible film.

9. The backlight unit of claim 8, wherein the light source device is formed at the one end portion of the flexible film, and a non-adhesive portion of the flexible film where the adhesive portion is not formed is in front of a portion of the flexible film where the light source device is formed.

10. The backlight unit of claim 9, wherein the non-adhesive portion of the flexible film is located in an area contacting the upper surface of the side portion of the light guide panel.

11. The backlight unit of claim 9, wherein a length of the upper surface of the side portion of the light guide panel extending in the one direction is greater than a length of the flexible film in the one direction.

12. The backlight unit of claim 11, wherein the non-adhesive portion of the flexible film covers corresponding areas of the upper surface of the side portion of the light guide panel and the light source device is disposed in front of a side wall of the light guide panel.

13. The backlight unit of claim 1, further comprising:
a plurality of optical sheets formed on a surface of the light guide panel facing towards the display apparatus; and
a reflective sheet formed on another surface of the light guide panel facing away from the display apparatus.

14. The backlight unit of claim 1, wherein the light guide panel comprises:
a light guide portion guiding light to the display apparatus; and
a side portion extending from the light guide portion, the side portion comprising:
a light incident portion thicker than the light guide portion; and
an inclined portion that connects the light guide portion and the light incident portion,
wherein the side portion extends from and is spaced apart from the light guide portion in parallel.

15. A display module comprising:
a display apparatus displaying an image;
a backlight unit formed below the display apparatus, the backlight unit comprising:
a light guide panel guiding light to the display apparatus; and
a circuit board formed at a side of the light guide panel and including light source devices mounted thereon; and
a light leakage preventing portion formed in a portion of the circuit board attached to the light guide panel, the light leakage preventing portion comprising:
an interval removing portion formed in the light guide panel; and
an adhesive portion attached to the interval removing portion and formed in the circuit board.

16. The display module of claim 15, wherein the interval removing portion comprises a plurality of grooves each formed to correspond to a portion to which the adhesive portion is attached, and
wherein the interval removing portion is formed to have a height different from a height of an upper surface of a side portion of the light guide panel in one direction of the side portion of the light guide panel.

17. The display module of claim 15, wherein a thickness of the interval removing portion from an upper surface of the side portion of the light guide panel to a bottom surface of the interval removing portion is the same as or greater than a thickness of the adhesive portion so as to completely accommodate the adhesive portion.

18. The display module of claim 15, wherein the light source devices are formed at one end portion of the flexible film and a non-adhesive portion of the circuit board is formed in front of a portion of the circuit board having the light source devices mounted thereon.

19. The display module of claim 18, wherein the non-adhesive portion of the flexible film is located in an area contacting an upper surface of a side portion of the light guide panel.

20. A display module comprising:
a liquid crystal display (LCD) panel comprising:
first and second polarizing plates; and
first and second substrates disposed between the first and second polarizing plates;
a backlight illuminating the LCD panel;
a light guide panel guiding light towards the LCD panel, the light guide panel comprising:
interval removing portions formed on an upper surface of a side portion of the light guide panel, and disposed at regular intervals along one direction of the light guide panel;
adhesive portions corresponding to and disposed in the interval removing portions; and
a case encasing the LCD panel, the backlight and the light guide panel.

21. The display module of claim 20, further comprising a circuit board having a plurality of light source devices disposed thereon at predetermined distances,
wherein the light source devices are disposed so at to correspond to areas of the light guide panel not having the adhesive portions, and
wherein the adhesive portions adjoin the circuit board to the upper surface of the side portion of the light guide panel.

22. The display module of claim 20, wherein the interval removing portions have a depth extending into the side portion of the light guide panel approximately equal to a depth of the adhesive portions of the light guide panel so that a top side of the adhesive portions form a horizontal plane with the upper surface of the side portion of the light guide panel.

23. The display module of claim 23, wherein the circuit board is a flexible film including a wiring connecting the light source devices.

24. The display module of claim 21, wherein the light source devices abut a side wall portion of the side portion of the light guide panel and the circuit board is disposed on the upper surface of the side portion of the light guide panel.

25. The display module of claim 24, wherein the side portion of the light guide panel has an inclined portion opposite to the side wall portion of the side portion of the light guide panel,
wherein the inclined portion slopes downward from the upper surface of the side portion of the light guide panel towards a flat portion of the light guide panel.

26. A light guide panel of a display apparatus having a liquid crystal display panel and a backlight including optical sheets and a circuit board with light source devices disposed thereon, the light guide panel comprising:
a flat light guide portion disposed below the optical sheets of the backlight; and
a side portion disposed at a side of the light guide panel not below the optical sheets and having interval removing portions formed on an upper surface of the side portion of the light guide panel.

27. The light guide panel of claim 26, wherein the interval removing portions have a depth receding from an upper surface of the side portion approximately equal to a depth of adhesive tape affixing the circuit board to the light guide panel.

28. The light guide panel of claim 27, wherein the side portion comprises:
a side wall disposed opposite to the flat light guide portion; and
an inclined portion sloping downwards from the upper surface of the side portion of the light guide panel towards the flat light guide portion,
wherein the light source devices of the circuit board abut the side wall.
